(19) United States
(12) Patent Application Publication
(10) Pub. No.: US 2014/0204704 A1
(43) Pub. Date: Jul. 24, 2014

(54) SYSTEMS AND METHODS FOR IMPROVING BANDWIDTH OF WIRELESS NETWORKS

(71) Applicant: Wireless Seismic, Inc., Louisville, CO (US)

(72) Inventor: Douglas B Crice, Grass Valley, CA (US)

(73) Assignee: Wireless Seismic, Inc., Louisville, CO (US)

(21) Appl. No.: 14/171,579

(22) Filed: Feb. 3, 2014

Related U.S. Application Data
(63) Continuation of application No. 12/981,980, filed on Dec. 30, 2010, now abandoned.

(51) Int. Cl. G01V 1/22

(52) U.S. Cl. CPC G01V 1/22
USPC 367/14

(57) ABSTRACT

Systems and methods for seismic data acquisition with location aware network nodes. Based on location information of the nodes of the network, a multiplexing signature may be provided for the node. The location information may be used in conjunction with other information (e.g., location information of other nodes in the network and transmission ranges for nodes in the network) to determine collision domains. A multiplexing signature may be assigned to a node based on information regarding a collision domain to which the node belongs. As such, the assigned multiplexing signature may be used to avoid data collisions.

### RELATED APPLICATIONS

This application is a continuation of U.S. patent application Ser. No. 12/981,980, filed Dec. 30, 2010, entitled “SYSTEMS AND METHODS FOR IMPROVING BANDWIDTH OF WIRELESS NETWORKS,” the entirety of which is hereby incorporated by reference.

### FIELD

The present invention generally relates to improving bandwidth usage of a wireless network for seismic data acquisition. Specifically, the present invention relates to assigning wireless modules in a seismic array multiplexing regimes based at least partially on location data obtained regarding the modules.

### BACKGROUND

Seismic surveys are often used by natural resource exploration companies and other entities to create images of subsurface geologic structure. These images are used to determine the optimum places to drill for oil and gas and to plan and monitor enhanced resource recovery programs among other applications. Seismic surveys may also be used in a variety of contexts outside of oil exploration such as, for example, locating subterranean water and planning road construction.

A seismic survey is normally conducted by placing an array of vibration sensors (accelerometers or velocity sensors called “geophones”) on the ground, typically in a line or in a grid of rectangular or other geometry. Vibrations are created either by explosives or a mechanical device such as a vibrating energy source or a weight drop. Multiple energy sources may be used for some surveys. The vibrations from the energy source propagate through the earth, taking various paths, refracting and reflecting from discontinuities in the subsurface, and are detected by the array of vibration sensors. Signals from the sensors are amplified and digitized, either by separate electronics or internally in the case of “digital” sensors. The survey might also be performed passively by recording natural vibrations in the earth.

The digital data from a multiplicity of sensors is eventually recorded on storage media, for example magnetic tape, or magnetic or optical disks, or other memory device, along with related information pertaining to the survey and the energy source. The energy source and/or the active sensors are relocated and the process continued until a multiplicity of seismic records is obtained to comprise a seismic survey. Data from the survey are processed on computers to create the desired information about subsurface geologic structure.

In general, as more sensors are used, placed closer together, and/or cover a wider area, the quality of the resulting image will improve. It has become common to use thousands of sensors in a seismic survey stretching over an area measured in square kilometers. Hundreds of kilometers of cables may be laid on the ground and used to connect these sensors. Large numbers of workers, motor vehicles, and helicopters are typically used to deploy and retrieve these cables. Exploration companies would generally prefer to conduct surveys with more sensors located closer together. However, additional sensors require even more cables and further raise the cost of the survey. Economic tradeoffs between the cost of the survey and the number of sensors generally demand compromises in the quality of the survey.

In addition to the logistic costs, cables create reliability problems. Besides normal wear-and-tear from handling, they are often damaged by animals, vehicles, lightning strikes, and other problems. Considerable field time is expended troubleshooting cable problems. The extra logistics effort also adds to the environmental impact of the survey, which, among other things, adds to the cost of a survey or eliminates surveys in some environmentally sensitive areas.

As a result, wireless acquisition units have been developed to do away with the burdensome nature of cables in such a system. For instance, U.S. Pat. No. 7,773,457, which is hereby incorporated in its entirety by reference, describes a system for performing a seismic survey using wireless acquisition units. Such wireless systems may generally behave as a wireless network (e.g., a mesh network or other ad hoc network). Additionally, the systems may employ a variety of networking techniques. For example, wireless acquisition units within the array may employ a mesh network style topology to transmit data to base station. The station base may use alternative styles of point to point communications or networking.

In this regard, the wireless survey systems described in the above-referenced patent may be subject to limitations of the particular wireless networking protocol employed. For instance, one known issue that has been identified with mesh networks (e.g., such as 802.11 networks) occurs when individual nodes attempt to communicate while other nodes operating on the same frequency are also communicating. When such a data collision occurs, both units stop and attempt to communicate later. In the instance where a large number of nodes provided in the same area, the bandwidth is diminished because the repeated collisions prevent nodes from communicating until such time that they find an available slot. This problem may also occur with other multiplexing regimes such that in addition to nodes operating at the same time period, nodes may attempt to operate using the same frequency, code, or other multiplexing signature at which time the nodes upon a collision must wait and retransmit at a later time.

### SUMMARY

It has been recognized that rather than this trial and error type system wherein a node attempts to communicate until a collision occurs and wait until a later time to reestablish communication, systems and methods of wireless units may be deployed that utilize location data associated with each of the nodes to establish multiplexing regimes that do not rely on this trial and error approach which reduces bandwidth. Such a system that establishes a multiplexing regime based on location data may be particularly useful in the field of seismic data acquisition. Because establishing a multiplexing regime based on location data of the individual modules may allow the bandwidth to reach its potential maximum, the likelihood of a real-time data readout slowing a seismic survey is in turn reduced.

Accordingly, a first aspect includes a method for use in seismic data acquisition. The method includes locating a plurality of wireless modules that are operative to wirelessly communicate seismic data, identifying one or more collision domains of the plurality of wireless modules at least partially based on the locating, and assigning different multiplexing signatures to each wireless module within any given one collision domain. The method also includes transmitting seismic data employing the plurality of wireless modules using the assigned multiplexing signatures.

A number of feature refinements and additional features are applicable to the first aspect. These feature refinements and additional features may be used individually or in any combination. As such, each of the following features that will be discussed may be, but are not required to be, used with any other feature or combination of features of the first aspect.

In one embodiment, the locating may comprise obtaining location data from a GPS receiver. Additionally or alternatively, the locating may comprise using at least one of an angle of arrival technology, a time difference of arrival technology or a signal strength technology.

In another embodiment, the identifying may include ascertaining a plurality of collision domains among the plurality of wireless modules. A common multiplexing signature may be employed by a first wireless module and a second wireless module. The first and second wireless modules may be in different ones of the plurality of collision domains.

In yet another embodiment, the multiplexing signatures may comprise a plurality of temporally distinct time slots. Additionally or alternatively, the multiplexing signatures may comprise a plurality of frequencies. Further still, the multiplexing signatures may comprise a plurality of codes.

In another embodiment, the plurality of wireless modules may comprise at least one seismic data acquisition module. Additionally, the plurality of wireless modules may comprise at least one data collection unit.

A second aspect includes a system for use in seismic data acquisition. The system includes a plurality of wireless modules, disposed in series, operable to wirelessly communicate seismic data. The wireless modules define a wireless serial data transfer path for relaying seismic data from upstream modules to downstream modules and a data collection unit. The system further includes a first wireless module at a first location in said serial data transfer path for transmitting seismic data having a first positioning module operable to determine first location information regarding the first location. Additionally, the system includes a second wireless module at a second location in said serial data transfer path for transmitting seismic data having a positioning module operable to determine second location information regarding the second location. The first wireless module is assigned a first multiplexing signature based at least partially on the first location information received from the first positioning module, and the second wireless module is assigned a second multiplexing signature based on the second location information received from the second positioning module.

A number of feature refinements and additional features are applicable to the second aspect. These feature refinements and additional features may be used individually or in any combination. As such, each of the following features that will be discussed may be, but are not required to be, used with any other feature or combination of features of the second aspect.

In one embodiment, the first location may be separated from the second location by a distance equal to or less than a transmission range of the first and second wireless modules, and the first and second multiplexing signatures are different. Alternatively, the first location may be separated from the second location by a distance greater than a transmission range of the first and second wireless modules, and the first and second multiplexing signatures are the same. In an embodiment, the plurality of wireless modules may comprise at least one data acquisition module. In yet another embodiment, the first and second multiplexing signatures may comprise at least one of a plurality of temporally distinct time periods, a plurality of codes, and a plurality of frequencies.

Furthermore, a number of feature refinements and additional features are applicable to any of the foregoing aspects. These feature refinements and additional features may be used individually or in any combination. As such, each of the following features may be, but are not required to be, used with any other feature or combination of features of the foregoing aspects.

For example, the multiplexing sequence for the one or more modules described above may reside in non-volatile storage at each unit. That is, the multiplexing sequence may be stored locally in a memory of the module. Alternatively or additionally, the multiplexing sequence may be transmitted among units (e.g., from a base unit to individual units disposed in the array). In this regard, the multiplexing sequence may be updated or modified during a survey. The transmitted sequence may in turn be stored in memory once received at the module.

In addition, the modules may comprise a seismic array. The seismic array may be of any appropriate configuration. For example, the modules of any of the foregoing aspects may be arranged in lines to communicate to a base station. The modules may transmit to an adjacent module in the line or the modules may transmit to a non-adjacent module. As such, each module may communicate sequentially down the line to the base station or each module may jump adjacent modules and transmit to non-adjacent downstream modules.

### BRIEF DESCRIPTION OF THE FIGURES

FIG. 1 is a schematic view of an embodiment of a wireless unit.

FIG. 2 is a schematic view of a wireless array of an embodiment of a wireless array.

FIG. 3 is a schematic view of a linear array of wireless units operating with a multiplexing regime imparted based on location information.

FIG. 4 is a schematic view of a plurality of wireless units operating in a two dimensional array using a multiplexing regime based on location information of the individual nodes.

FIG. 5 is a flow chart depicting an embodiment of a process according to the present disclosure.

FIG. 6 is a schematic view of another embodiment of a wireless array.

FIG. 7 is a schematic view of a portion of an embodiment of a wireless array shown in three different instances of operation.

FIG. 8 is a schematic view of yet another embodiment of a wireless array.

FIG. 9 is a schematic view of a wireless array shown at various instances of operation.

FIG. 10 is a schematic view of still another embodiment of a wireless array.

### DETAILED DESCRIPTION

The present disclosure is generally applicable to wireless networks with location aware nodes having collision domains. A collision domain refers to an area including multiple nodes of a wireless network that may experience data collisions (i.e., interference or crosstalk). As such, data attempted to be transmitted by the nodes may collide and a transmission may fail. In such instances where a collision is experienced, the nodes may terminate communication and attempt to retransmit the data which subject to the collision at a later time. This type of system presents particular problems as the number of nodes within a given collision domain increases. As the number of nodes in the given collision domain that attempt to communicate increases, the greater the probability that a collision will occur.

Oftentimes, the nodes of a wireless network are location unaware. For instance, in a common 802.11 network, there may be multiple nodes, some of which may be located within transmission range of another node. The nodes may be location unaware and not be privy to the relative location of other nodes within the network. In this regard, the above-noted techniques of retransmission at a later time may be employed to overcome a data collision.

However, when nodes are location aware, collision domains in the network may be identified prior to actual collisions occurring. That is, the location of a node along with a known transmission range of a node may define a collision domain for that particular node. In this regard, all other nodes located within the transmission range of the given node may be within the collision domain of a particular node.

In this regard, measures may be taken to prevent collisions prior to collisions occurring. In turn, the bandwidth of the given system may approach a theoretical maximum. For instance, location data for nodes in a given collision domain may be analyzed and the nodes may be provided with different multiplexing signatures of a multiplexing regime.

As used herein, a multiplexing regime is intended to refer to a style of multiplexing wherein multiple nodes in a network may simultaneously communicate data wirelessly to another node. Examples of multiplexing regimes include, but are not limited to, frequency division multiplexing, time division multiplexing, code division multiplexing, or other appropriate multiplexing technique having unique multiplexing signatures which avoid collisions. In each of these multiplexing regimes, a multiplexing signature may be assigned to the nodes in the network. Examples of multiplexing signatures include unique frequencies, unique codes, unique time slots, or other unique signatures that may be used by an individual node to prevent collisions of data with other nodes of the network. As such, different multiplexing signatures may allow for transmission of data in a collision domain without collisions.

In this regard, nodes within a common collision domain may each be assigned different multiplexing signatures appropriately, as to avoid collisions. This may include assigning different time slots for nodes within a common collision domain, assigning different frequencies to nodes in a common collision domain, or assigning other appropriate multiplexing signature such nodes to prevent collisions. However, two nodes which do not belong to a common collision domain may be assigned the same multiplexing signature without the potential of a collision. In this regard, the same multiplexing signature may be used multiple times with an array so long as, based on the location data of the nodes, nodes having the same multiplexing signature are not located in a common collision domain.

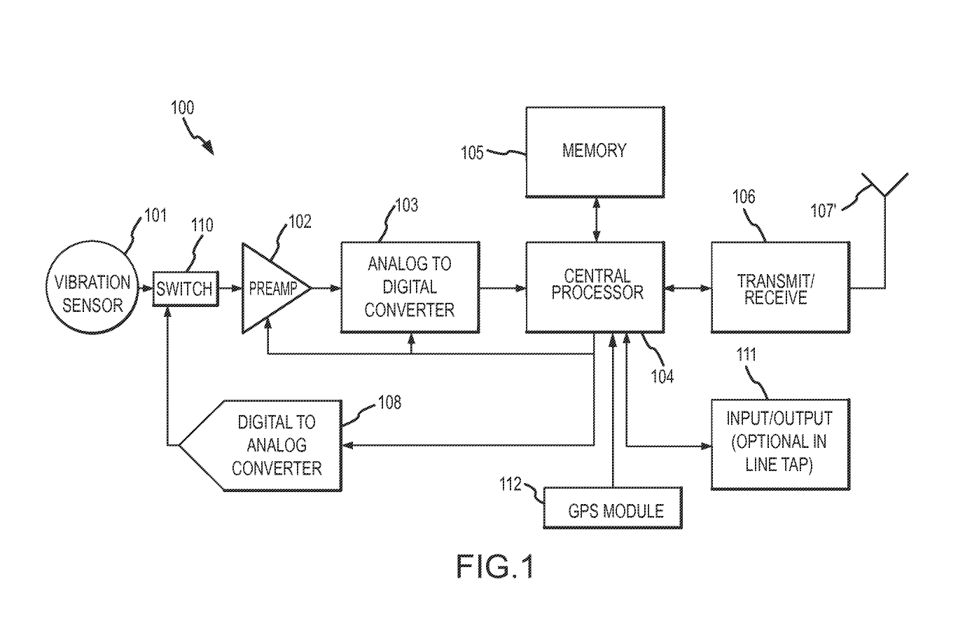

This concept of location aware nodes being assigned multiplexing signatures to avoid collisions may be particularly used in the field of wireless seismic arrays. One embodiment of a location aware acquisition unit that may be used in a wireless seismic array is shown in FIG. 1.

FIG. 1 shows a block diagram of a wireless remote acquisition and relay module 100 in accordance with an embodiment of the present invention. A vibration sensor 101 converts vibrations into electrical signals which are fed through switch 110 to preamplifier 102 and thence to the analog to digital (A/D) converter 103. The digital data from the A/D converter 103 is fed into the central processor 104 or directly into a digital memory 105. Alternately, in the case of a sensor 101 with direct digital output, the signals may flow directly to the processor 104 or memory 105.

In addition to controlling the system and storing the data in the memory, the processor 104 may perform some calculations on the data including decimation, filtering, stacking repetitive records, correlation, timing, etc. The remote module 100 may also receive information through the transceiver 106, for example: timing information, cross-correlation reference signals, acquisition parameters, test and programming instructions, location information, and seismic data from upstream modules and updates to the software among other commands. The transmit and receive signals couple through antenna 107.

The processor 104 can control the transceiver 106, including transmit/receive status, frequencies, power output, and data flow as well as other functions required for operation. The remote module 100 can also receive data and commands from another remote module or base station, store them in the memory, and then transmit them again for reception by another remote module up or down the line.

A digital-to-analog (D/A) converter 108 may be included in the system which can accept digital data from the processor 104 to apply signals through a switch 110 to the input circuitry. These signals, which may for example consist of DC voltages, currents, or sine waves, can be digitized and analyzed to determine if the system is functioning properly and meeting its performance specifications. Typical analysis might include input noise, harmonic distortion, dynamic range, DC offset, and other tests or measurements. Signals may also be fed to the sensor 101 to determine such parameters as resistance, leakage, sensitivity, damping and natural frequency. The power supply voltage may also be connected through the switch 110 to the A/D converter 103 to monitor battery charge and/or system power. The preamplifier 102 may have adjustable gain set by the processor 104 or other means to adjust for input signal levels. The vibration sensor 101 may be a separate generic unit external to the remote module 100 and connected by cables, or the sensor 101 might be integral to the remote module package.

If the remote module 100 is to be used as a base station, equivalent to a “line-tap” or interface to the central recording system, it will also have a digital input/output function 111 which may be, for example, an Ethernet, USB, fiber-optic link, or some computer compatible wireless interface (e.g., one of the IEEE 802.11 standards) or another means of communication through a wired or radio link. It may be acceptable to use larger battery packs for the line tap wireless data acquisition and relay modules because they will normally be relatively few in number and may communicate over greater distances using a high speed data communication protocol.

The remote module 200 may also include a GPS receiver 112. The GPS receiver 112 may be operative to receive signals from a number of GPS satellites that may be used in order to determine location and/or timing information. For instance, the remote module 100 may be able to self locate using the GPS receiver 112. While not shown, other location aware modules may be provided with the remote module 100. Alternatively or additionally, the remote module may be able to determine a relative location with respect to other modules in the array based on or more of an angle of arrival (AOA) technology, a time difference of arrival technology, or signal strength technology. In this regard, the remote module 100 may be operative to receive absolute or relative location information in order to self locate within a seismic array.

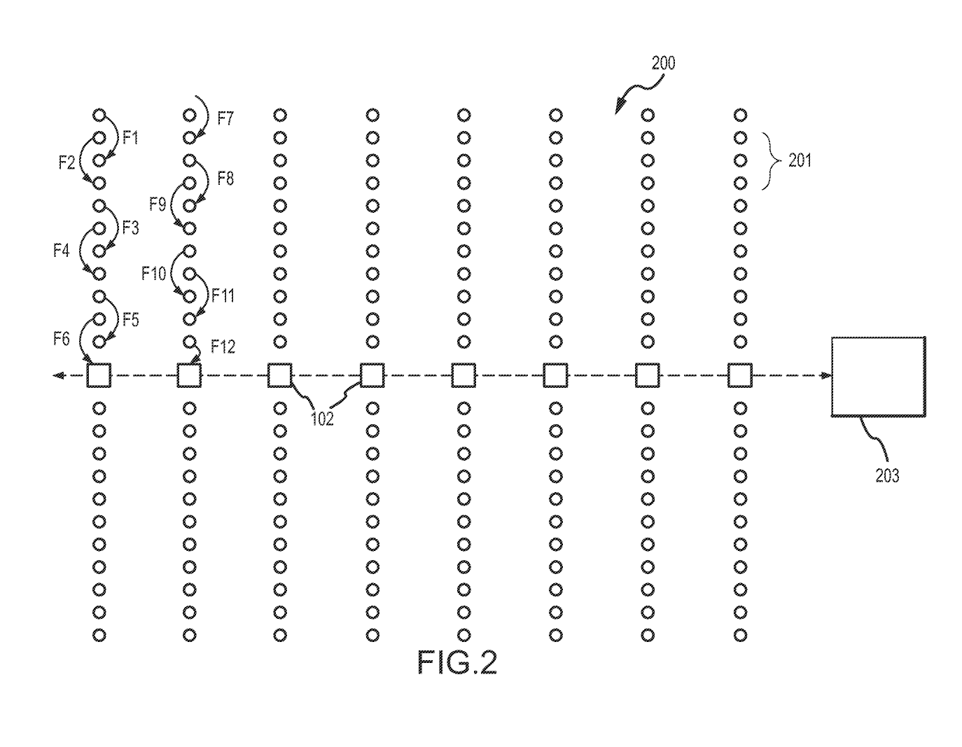

The remote module 100 is constructed of common integrated circuits available from a number of vendors. The Transmit/Receive integrated circuit 106 could be a digital data transceiver with programmable functions including power output, timing, frequency of operation, bandwidth, and other necessary functions. The operating frequency band may preferably be a frequency range which allows for unlicensed operation worldwide, for example, the 2.4 GHz range. The central processor 104, memory 105, and switch 110 can include any of a number of generic parts widely available. The A/D converter 103 could preferably be a 24-bit sigma delta converter such as those available from a number of vendors. The preamplifier 102 may be a low-noise, differential input amplifier available from a number of sources, or alternatively integrated with the ND converter 103. The D/A converter 108 may be a very low distortion unit which is capable of producing low-distortion sine waves which can be used by the system to conduct harmonic distortion tests. The module 100 may include a number of other components not shown in FIG. 2, such as a directional antennae for AOA signal measurements, separate transmit and receive antennae, separate antennae for location signals and seismic data transfer signals, batteries, etc.

The acquisition module depicted in FIG. 1 may be used in a system such as the one described in FIG. 2. FIG. 2 shows one possible configuration of a wireless seismic system in accordance with an embodiment of the present invention. A number of remote modules 201 may be arranged in lines as is done with previous wired systems, except that there is no physical connection between the remote modules. Base station modules 202 are provided which may be connected to a central control and recording system 203 by Ethernet, fiber optic, or other digital data link or a wireless substitute. Example radio links operating on frequencies F1 to F12 are indicated by arrows. Note that for improved data rate, each radio link in the illustrated embodiment leaps past the nearest remote module to the next module closer to the base station. Other radio transmission paths are possible, including direct to the nearest remote module, leaping multiple modules, or in the case of an obstruction or equipment fault, past a defective remote module or even across to another line or any other logical path that establishes a communication flow. The central control and recording system may be a notebook computer or larger equivalent system.

In the various implementations of a wireless acquisition system described above, each of the wireless modules being controlled by a single base station may be referred to as a line segment. This line segment may be further divided into one or more subnets. Each subnet may comprise an independent serial data transfer path in a line segment. In this regard, and as shown in FIG. 1, a base station unit 102 may be disposed such that a portion of the line segment are arranged on opposite sides of the base station. That is, the base station may reside at a point within the line segment. The portions on either side of the base station of the line segment may be symmetric or may not be symmetric. The portions of the line segment on either side of the base station may each comprise a subnet such that each module transmits to an adjacent module rather than the embodiment depicted in FIG. 1 wherein each module transmits to a non-adjacent module nearer the base station. Furthermore, each portion of the line segment on either side of the base station may comprise multiple subnets as shown wherein modules transmit to non-adjacent modules. In this regard, modules may be interleaved such that there is more than one subset in a line segment.

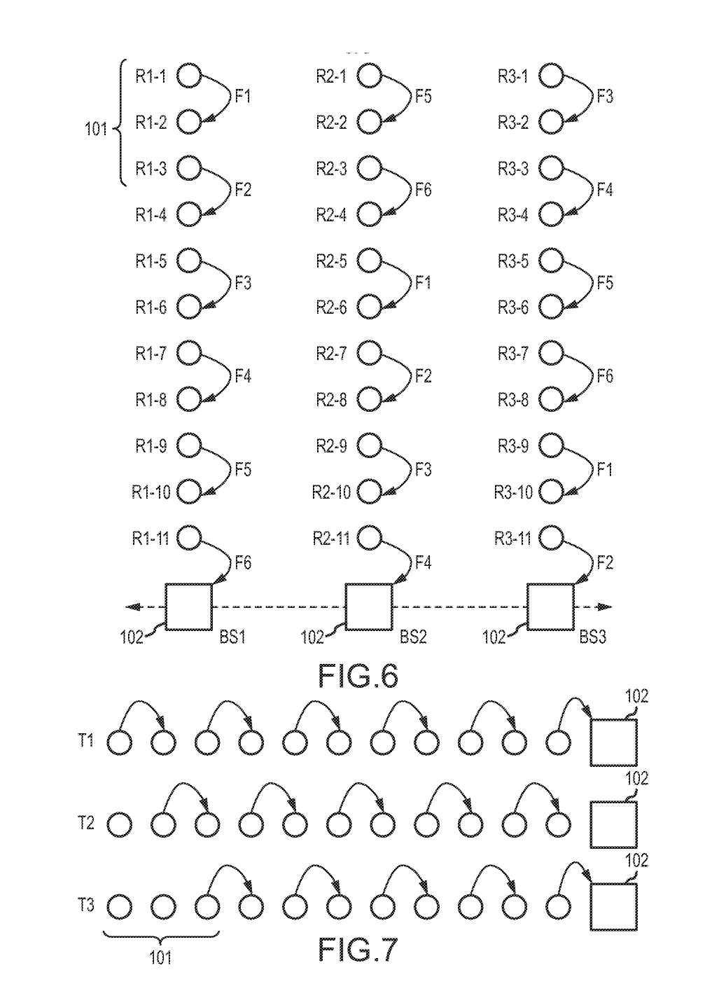

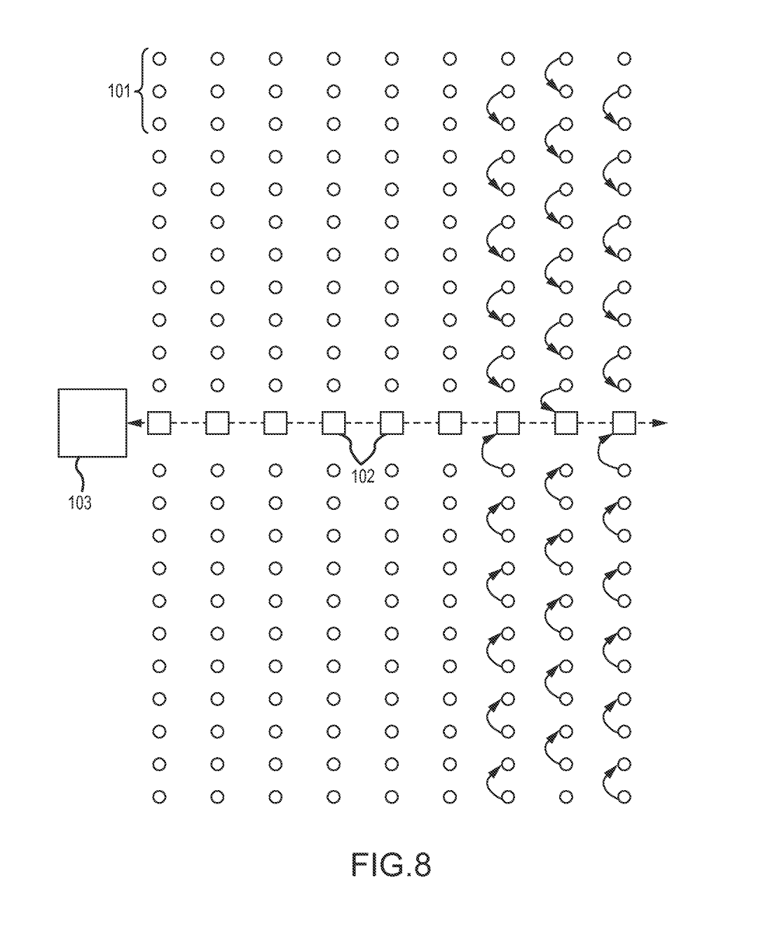

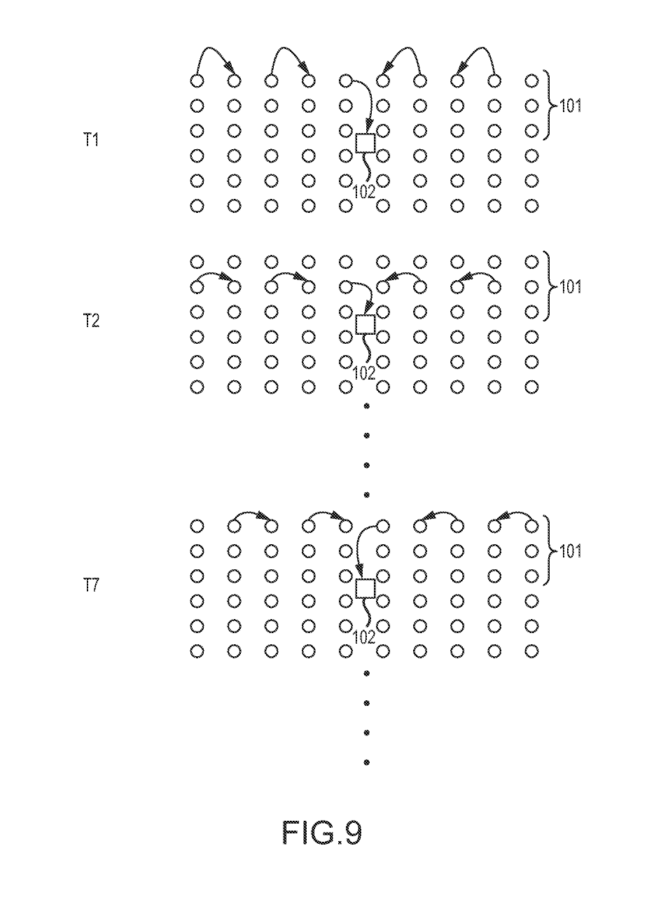

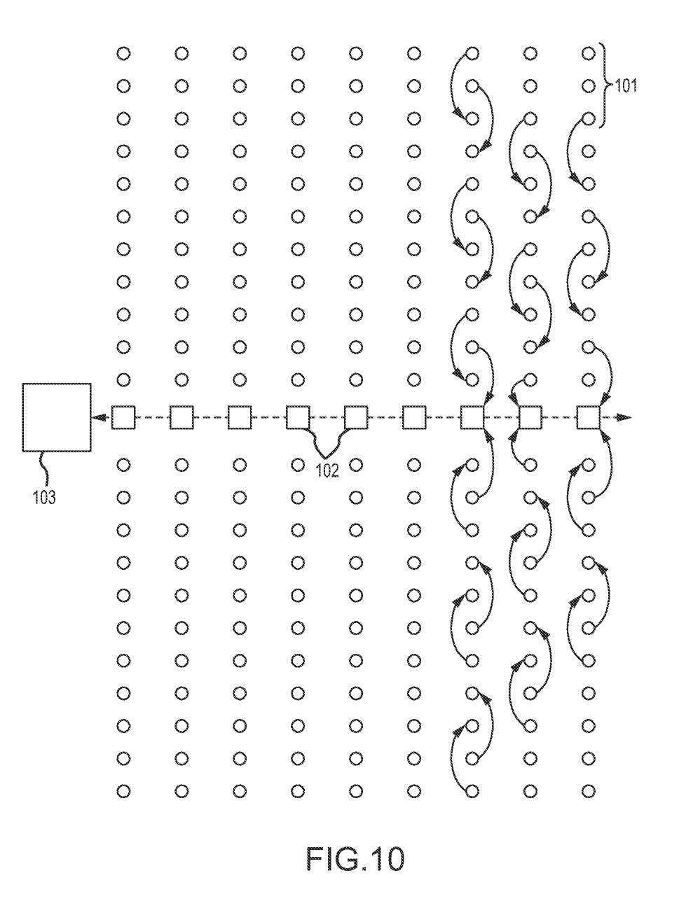

For example, with additional reference to FIG. 6, each module 101 may communicate with an adjacent module such that no modules are skipped. FIG. 7 shows a similar configuration as shown in FIG. 6, wherein each module 101 transmits to an adjacent module. FIG. 7 shows a portion of a line segment in various instances in time (T1, T2, and T3). At each successive time interval, different modules may transmit data (e.g., appending acquired seismic data to the transmission) such that the data is in turn passed down the line segment to a base station 102. A full array of this sort is shown in FIG. 8. Note that either side of a line segment may each comprise a subnet of modules. The base stations 102 may receive a transmission from a respective one of the different subnets in different transmission cycles. In this regard, and as illustrated in FIG. 9, a number of subnets may be provided that may transmit data back to a base station 102. The number of subnets may correspond on the number of cycles required for each subnet to subsequently transmit data to the base station 102. Alternatively, as shown in FIG. 10, base stations 102 may be provided with multiple radios to receive transmissions from more than one subnet at the same time. In this regard, for an embodiment wherein the base station unit interrupts the line segment and is positioned therein, the base station unit may have multiple radios operative to receive the data multiple subnets at the same time. Alternatively, the subnets may transmit to the base station in alternating time periods such that each subnet transmits data to the base station at different periods as shown in FIGS. 7-9.

In this regard, the remote modules 201 may be positioned within transmission range of one or more other remote modules. As such, each remote module may be within transmission range of one or more other remote modules to which the remote modules is not to transmit data. Accordingly, collision domains (e.g., areas having the potential for interference or crosstalk between modules) are introduced into the system. Each module may have a unique collision domain wherein potential interference with other modules may occur. One or more of a multitude of multiplexing techniques may be used such that the modules avoid collisions of transmitted data. For instance, as shown each of the remote modules 201 transmitting data as represented in FIG. 2 may do so on one of a different frequency ranging from F1 to F12. In this regard, even if all the transmissions shown in FIG. 2 occur during a common transmission period, each of the frequencies allowed for multiplexing such that the simultaneous transfer does not result in collisions of data. Accordingly, modules receiving data may only listen for the particular multiplexing signature of its unit pair. Other multiplexing techniques may be used. For example, each of the transmitting remote modules may use a different code for code division multiplexing such that each code is different in this same respect each frequency is different as shown in FIG. 2. In any regard, the multiplexing signatures corresponding to the multiplexing technique may be predefined values stored in memory at each of the modules. These values may be stored on the units prior to deployment into the survey area. Alternatively, the multiplexing signature may be transmitted to the unit once deployed.

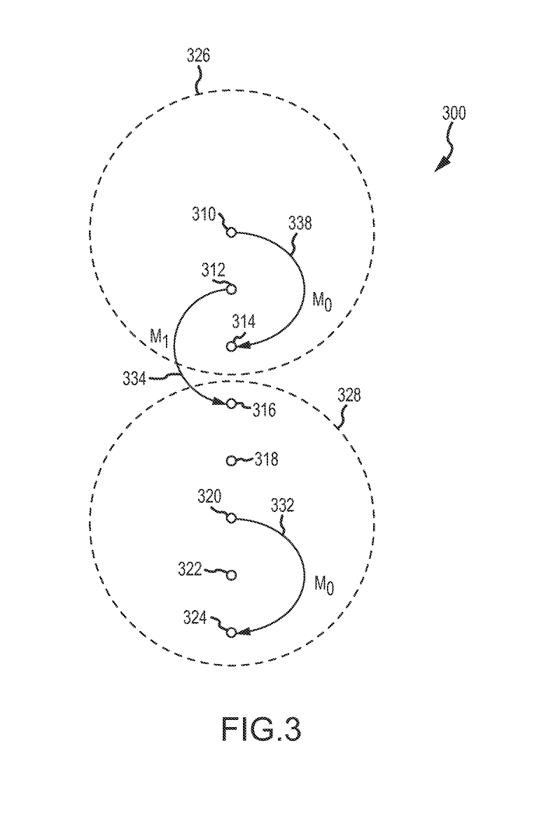

With reference to FIG. 3, plurality of wireless modules 310-324 are arranged in a generally linear fashion. FIG. 3 depicts an instance where one or more of the wireless modules 310-324 may be operating to transmit data. For instance, wireless module 310 is depicted as having a transmission range 326. In this regard, modules 312 and 314 are both within transmission range of module 310. In other words, modules 310, 312, and 314 belong to a common collision domain. Module 320 is depicted as having a transmission range 328. In this regard, modules 316, 318, 322, and 324 are within transmission range of module 320 (i.e., modules 316-324 all belong to a common collision domain). In this regard, a transmission 338 between module 310 and module 314 may use a first multiplexing signature M₀ and transmission 332 between module 320 and 324 may use the same multiplexing signature M₀. However, a transmission 334 from module 312 to module 316 may require a different multiplexing signature M₁ because module 312 is in a collision domain with module 310. If module 312 were to operate using multiplexing signature M₀ a data collision would occur.

Because each of the modules 310-324 may include location awareness (e.g., by way of a GPS receiver or some other navigational location technique), the manner in which multiplexing signatures M₀ and M₁ are assigned may be based on the location of module 310-312. That is, the location data associated with module 310 and the location data associated with module 312 along with known transmission ranges of the modules may indicate that module 310 and 312 are in a common collision domain such that different multiplexing signatures should be assigned. In a similar regard, the location data associated with module 320 may be compared to that associated with module 310 such that it is known that module 312 is outside the collision domain of module 310. In this regard, the same multiplexing signature M₀ may be used for the two modules 310 and 320.

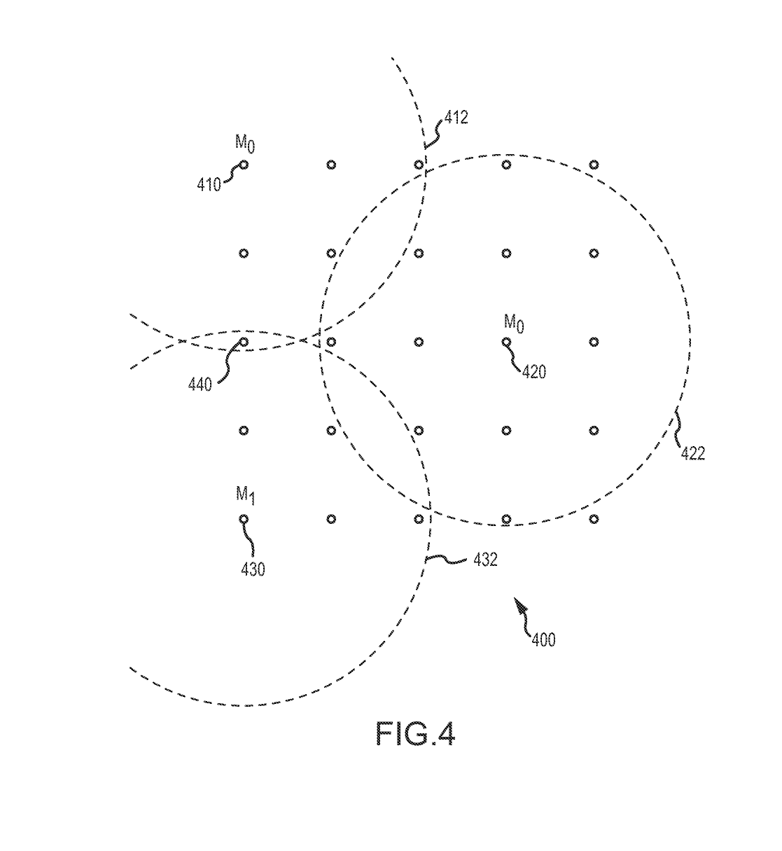

This concept may be extended to a two dimensional array 400 as shown in FIG. 4. FIG. 4 depicts a first module 410 having a transmission range 412. Similarly, module 420 is depicted as having a transmission radius 422. In this regard, module 410 and module 420 may both operate using multiplexing signature M₀. However, module 430 having a transmission range of 432 may overlap the transmission range 412 with module 410. In this regard, module 440 may be subject to the collision domain of module 410 and module 430. In this regard, if both module 410 and module 430 were to use the same multiplexing signature, the transmission to module 440 may result in a data collision where the two collision domains overlap. As such, module 430 may operate using a multiplexing signature M₁.

In that the multiplexing signature is assigned to various nodes in the wireless network are done so using location data of the wireless nodes, a assigning algorithm may be developed which takes into consideration the location of the nodes as well as the transmission range of each of the nodes to identify collision domains and assign multiplexing signatures appropriately to prevent collisions. In this regard, upon initiation (i.e., prior to seismic data being transmitted within the system), this assigning algorithm may be employed in order to initiate communications between the modules. As such, the appropriate number in arrangement of multiplexing signatures may be provided to the nodes such that once seismic data begins to be transmitted within the system, collisions are avoided and bandwidth is maximized.

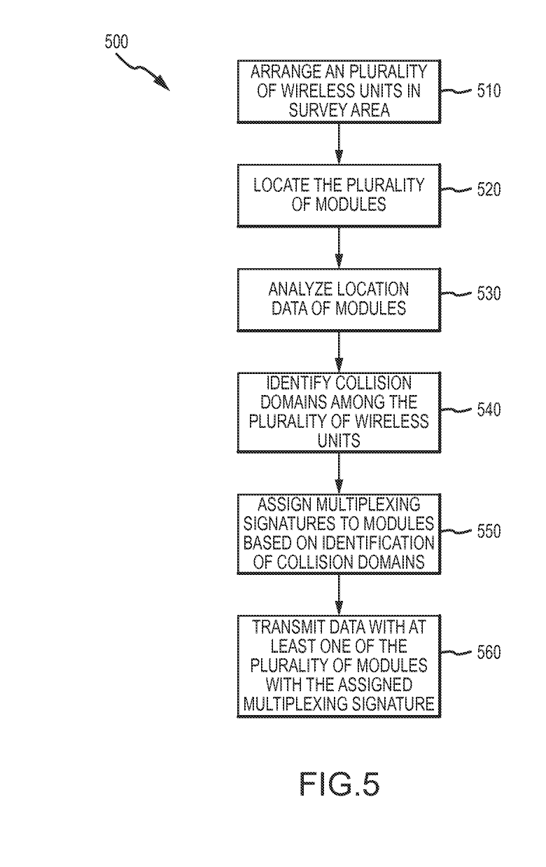

One embodiment of a process for assigning multiplexing signatures at least partially based on location is depicted in FIG. 5. The process 500 may include arranging 510 the plurality of wireless units in the survey area. Additionally, the process 500 may include locating 520 the plurality of modules. The locating 520 may occur during a deployment wherein the plurality of wireless units are arranged 510 in the survey area. In this regard, the arranging 510 and locating 520 may actually occur during a common operation (e.g., when each of the wireless units is deployed). Location data derived from the locating 520 may be analyzed 530 to determine locations of modules within the survey area. This location data may be used to identify 540 collision domains among the plurality of wireless units in the array. A plurality of collision domains may exist among the array. For instance, each individual module may have a unique collision domain. In this regard, multiple collision domains may be considered when assigning 550 multiplexing signatures to modules based on the identified collision domains. The process 500 may further include transmitting 560 data with at least one of the plurality of modules using the assigned multiplexing signature derived at least partially based on the location of the module.

In addition, the wireless modules described herein may be location aware. In this regard, and as described in U.S. Pat. No. 7,773,457, the modules may have components that are operative to obtain location data for the module. A module which has obtained location data may transmit its location data to another module in the array which has yet to locate itself. In this regard, the location data transmitted from the location aware module to the locating module may be used by the locating module to acquire a location. For instance, when a GPS module is provided to obtain location data, ephemeris data of a wireless module which is used to acquire a GPS location may be provided to another module which is yet to acquire a location data from a satellite. In this regard, the ephemeris data may be used by the locating wireless module to obtain location data. This may improve the locating modules ability to require satellite location data. For instance, the time required to acquire a satellite fix may be reduced such that the modules may be deployed and located faster.

Furthermore, while discussed above with regard to wireless acquisition units within a wireless array, the similar technique may also be employed at base stations or other nodes within the seismic data survey. For instance, a backbone of the survey comprised of base station modules 202 may also employ location data in order to arrange multiplexing signatures among the base station modules 202 in order to maximize bandwidth thereof.

Additionally, while the invention has been illustrated and described in detail in the drawings and foregoing description, such illustration and description is to be considered as exemplary and not restrictive in character. For example, certain embodiments described hereinabove may be combinable with other described embodiments and/or arranged in other ways (e.g., process elements may be performed in other sequences). Accordingly, it should be understood that only the preferred embodiment and variants thereof have been shown and described and that all changes and modifications that come within the spirit of the invention are desired to be protected.

What is claimed is:

1. A method for use in seismic data acquisition, comprising:
locating a plurality of wireless modules that are operative to wirelessly communicate seismic data;
identifying one or more collision domains of the plurality of wireless modules at least partially based on the locating;
assigning different multiplexing signatures to each wireless module within any given one collision domain; and
transmitting seismic data employing the plurality of wireless modules using the different multiplexing signatures.

2. The method according to claim 1, wherein the locating comprises obtaining location data from a GPS receiver.

3. The method according to claim 1, wherein the locating comprises using at least one of an angle of arrival technology, a time difference of arrival technology or a signal strength technology.

4. The method according to claim 1, wherein the identifying includes ascertaining a plurality of collision domains among the plurality of wireless modules.

5. The method according to claim 4, wherein a common multiplexing signature is employed by a first wireless module and a second wireless module, the first and second wireless modules being in different ones of the plurality of collision domains.

6. The method according to claim 5, wherein the multiplexing signatures comprise a plurality of temporally distinct time slots.

7. The method according to claim 5, wherein the multiplexing signatures comprise a plurality of frequencies.

8. The method according to claim 5, wherein the multiplexing signatures comprise a plurality of codes.

9. The method according to claim 1, wherein the plurality of wireless modules comprise at least one seismic data acquisition module.

10. The method according to claim 1, wherein the plurality of wireless modules comprise at least one data collection unit.

11. A system for use in seismic data acquisition, comprising:
a plurality of wireless modules, disposed in series, operable to wirelessly communicate seismic data, wherein said wireless modules define a wireless serial data transfer path for relaying seismic data from upstream modules to downstream modules and a data collection unit;
a first wireless module at a first location in said serial data transfer path for transmitting seismic data having a first positioning module operable to determine first location information regarding the first location; and
a second wireless module at a second location in said serial data transfer path for transmitting seismic data having a positioning module operable to determine second location information regarding the second location;
wherein the first wireless module is assigned a first multiplexing signature based at least partially on the first location information received from the first positioning module and the second wireless module is assigned a second multiplexing signature based on the second location information received from the second positioning module.

12. The system according to claim 11, wherein the first location is separated from the second location by a distance equal to or less than a transmission range of the first and second wireless modules and the first and second multiplexing signatures are different.

13. The system according to claim 11, wherein the first location is separated from the second location by a distance greater than a transmission range of the first and second wireless modules and the first and second multiplexing signatures are the same.

14. The system according to claim 11, wherein the plurality of wireless modules comprise at least one data acquisition module.

15. The system according to claim 14, wherein the first and second multiplexing signatures comprise at least one of a plurality of temporally distinct time periods, a plurality of codes, and a plurality of frequencies.

16. The system according to claim 1, wherein the different multiplexing signatures are stored in a memory at each wireless module.

17. The system according to claim 16, wherein the different multiplexing signatures are stored in the memory prior to deployment of the wireless modules into a survey area.

18. The system according to claim 1, wherein the different multiplexing signatures are transmitted to each wireless modules after deployment.
